(19) United States
(12) Patent Application Publication
(10) Pub. No.: US 2005/0160463 A1
(43) Pub. Date: Jul. 21, 2005

(54) Digital television broadcasting receiver

(75) Inventors: Masako Wakisaka, Osaka City (JP); Kiyoshi Matsumoto, Izumi City (JP)

Correspondence Address: ARENT FOX PLLC, 1050 CONNECTICUT AVENUE, N.W., SUITE 400, WASHINGTON, DC, 20036, US

(73) Assignee: Sanyo Electric Co., LTD

(21) Appl. No.: 11/053,239

(22) Filed: Feb. 9, 2005

Related U.S. Application Data
(62) Division of application No. 09/725,260, filed on Nov. 29, 2000.

(30) Foreign Application Priority Data
Dec. 2, 1999 (JP) 11-343703

(51) Int. Cl. H04B 1/18

(52) U.S. Cl. 725/68

(57) ABSTRACT

In a digital television broadcasting receiver comprising a control section for controlling the whole of the receiver, a program memory comprising a nonvolatile memory for storing character and figure data used for drawing various types of operation screens, and a volatile memory storing various types of data, stored in the nonvolatile memory as the character and figure data used for drawing the operation screens is data obtained by compressing the character and figure data (hereinafter referred to as compressed character and figure data), and the compressed character and figure data are decompressed and are expanded in the volatile memory at the time of initially starting the receiver.

### BACKGROUND OF THE INVENTION

1. Field of the Invention

The present invention relates to a digital television broadcasting receiver.

2. Description of the Prior Art

In a multichannel digital satellite broadcasting (CS broadcasting) system using a CS (Communication Satellite) which has been started in recent years, a lot of (e.g., not less than 100) channels are prepared, so that a lot of programs are provided. In such broadcasting, functions which have not so far known, for example, guide information relating to a program currently broadcast and a program broadcast in the future and information such as news from a transmission enterpriser, together with original program data, are transmitted at a predetermined time interval.

In a program for controlling a digital television broadcasting receiver, display data such as a program table or a menu is produced on the basis of the information. A user can select a program and watch news from the program table or the menu displayed on a screen.

An example of the digital television broadcasting receiver is one having the function of downloading a control program and rewriting the control program to the newest one such that the receiver can cope with the change of a broadcasting system.

In the digital television broadcasting receiver, a character font, figure bit map data, or the like used for producing an operation screen such as the program table or the menu in addition to the control program in a program memory must be stored in a storage device. Accordingly, a large-capacity memory is required as the program memory.

Particularly, many examples of the receiver having the function of rewriting the control program are ones comprising an area storing a current control program and an area storing data for rewriting to be downloaded. Accordingly, a large-capacity memory is required as a program memory.

### SUMMARY OF THE INVENTION

An object of the present invention is to provide a digital television broadcasting receiver capable of reducing the capacity of a program memory.

In a first digital television broadcasting receiver comprising a control section for controlling the whole of the receiver, a program memory comprising a nonvolatile memory for storing program data for the control section and character and figure data used for drawing various types of operation screens, and a volatile memory storing various types of data, a first digital television broadcasting receiver according to the present invention is characterized in that stored in the nonvolatile memory as the character and figure data used for drawing the operation screens are data obtained by compressing the character and figure data (hereinafter referred to as compressed character and figure data), and the compressed character and figure data are decompressed and are expanded in the volatile memory at the time of initially starting the receiver.

In a digital television broadcasting receiver comprising a control section for controlling the whole of the receiver, and a program memory comprising a nonvolatile memory for storing program data for the control section and character and figure data used for drawing various types of operation screens, a second digital television broadcasting receiver according to the present invention is characterized in that stored in the nonvolatile memory as the character and figure data used for drawing the operation screens are data obtained by compressing the character and figure data (hereinafter referred to as compressed character and figure data), and the necessary ones of the compressed character and figure data are successively decompressed and used.

In a digital television broadcasting receiver comprising a control section for controlling the whole of the receiver, and a program memory comprising an electrically rewritable nonvolatile memory for storing program data for the control section and character and figure data used for drawing various types of operation screens, a third digital television broadcasting receiver according to the present invention is characterized in that the program memory comprises two program storing areas, the program data currently used and data obtained by compressing the character and figure data (hereinafter referred to as compressed character and figure data) being stored in one of the program storing areas, and data obtained by decompressing the compressed character and figure data being stored in the other program storing area, and by comprising means for downloading data for rewriting including program data for rewriting and compressed character and figure data for rewriting and fed by broadcasting, and storing the downloaded data for rewriting in the program storing area (hereinafter referred to as second program storing area) different from the program storing area storing the program data currently used (hereinafter referred to as first program storing area), and means for initializing the first program storing area different from the second program storing area storing the data for rewriting after the downloading of the data for rewriting is terminated, and decompressing and storing the compressed character and figure data for rewiring acquired by the downloading in the initialized first program storing area.

Means for storing attached information fed by broadcasting may be provided in the program storing area storing data obtained by decompressing the compressed character and figure data for rewriting acquired by the downloading out of the two program storing areas.

In a digital television broadcasting receiver comprising a control section for controlling the whole of the receiver, and a program memory comprising an electrically rewritable nonvolatile memory for storing program data for the control section and character and figure data used for drawing various types of operation screens, a fourth digital television broadcasting receiver according to the present invention is characterized in that the program memory comprises two program storing areas, the program data currently used and data obtained by compressing the character and figure data (hereinafter referred to as compressed character and figure data) being stored in one of the program storing areas, and data obtained by decompressing the compressed character and figure data being stored in the other program storing area, and by comprising a circuit for downloading data for rewriting including program data for rewriting and compressed character and figure data for rewriting and fed by broadcasting, and storing the downloaded data for rewriting in the program storing area (hereinafter referred to as second program storing area) different from the program storing area storing the program data currently used (hereinafter referred to as first program storing area), and a circuit for initializing the first program storing area different from the second program storing area storing the data for rewriting after the downloading of the data for rewriting is terminated, and decompressing and storing the compressed character and figure data for rewiring acquired by the downloading in the initialized first program storing area.

A circuit for storing attached information fed by broadcasting may be provided in the program storing area storing data obtained by decompressing the compressed character and figure data for rewriting acquired by the downloading out of the two program storing areas.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a digital television broadcasting receiver having the function of receiving CS digital broadcasting;

FIGS. 2(a) and 2(b) are schematic views showing the contents of a program memory;

FIG. 3 is a flow chart showing the procedure for processing performed by a system control when a downloading instruction is entered; and

FIG. 4 is a schematic view showing the contents of a program memory in another embodiment.

### DETAILED DESCRIPTION OF THE PREFERRED EMBODIMENTS

Referring now to the drawings, embodiments of the present invention will be described.

[1] Description of First Embodiment

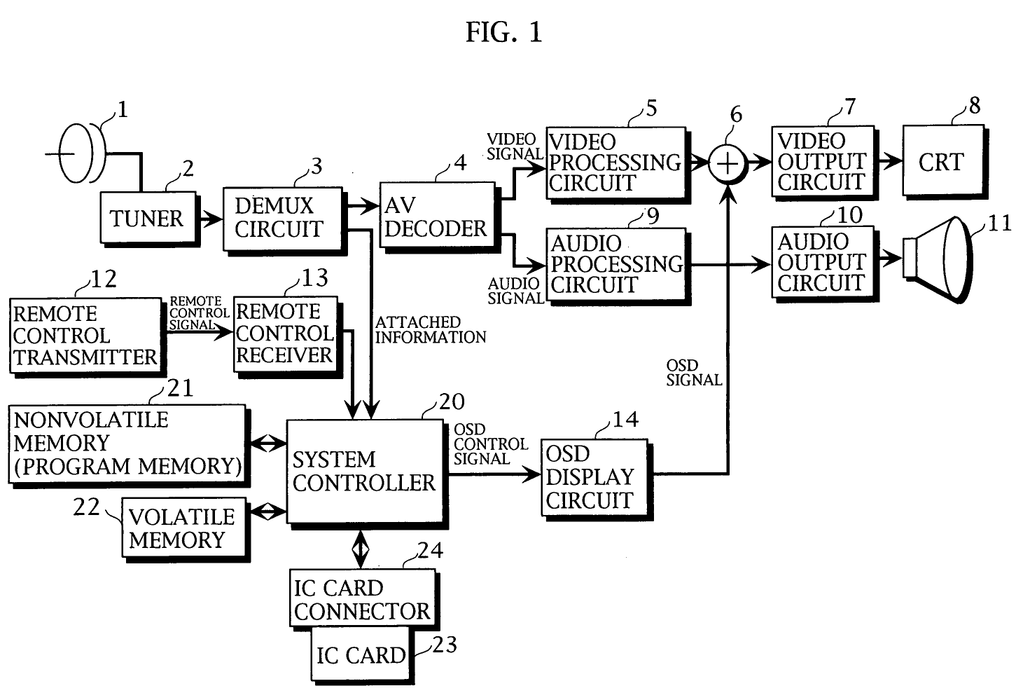

FIG. 1 illustrates the configuration of a digital television broadcasting receiver having the function of receiving CD digital broadcasting.

A CS broadcasting wave utilizing a communication satellite (CS) is sent to a tuner 2 through an antenna 1, and is subjected to high-frequency processing and demodulation. An output from the tuner 2 is fed to a DEMUX (Demultiplexer) circuit 3, where a packet is decoded.

In the DEMUX circuit 3, the packet is divided into MPEG (Motion Picture Expert Group) data and attached information such as program guide information. The MPEG data obtained by the division in the DEMUX circuit 3 is fed to an AV decoder 4. The attached information such as the program guide information obtained by the division in the DEMU circuit 3 is fed to a system controller 20.

In this example, the system controller 20 comprises a program memory 21 which is an electrically rewritable nonvolatile memory such as an EEPROM (Electrically Erasable and Programmable ROM) and a volatile memory 22 such as a RAM. Further, an IC card connector 24 to which an IC card 23 storing purchase hierarchy of pay programs, for example, is connected is connected to the system controller 20.

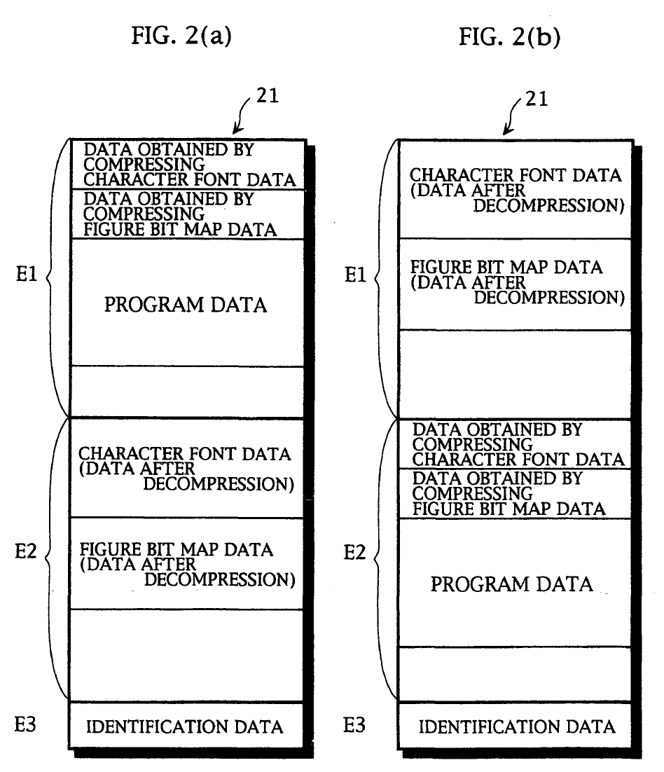

The program memory 21 is provided with two program storing areas E1 and E2 and an area E3 storing identification information indicating which of the areas stores currently effective program data, as shown in FIG. 2 (a).

The area E1, the area E2, and the area E3 shall be respectively referred to as a first area, a second area, and a third area. One of the first area E1 and the second area E2 is used as an area storing program data currently used (currently effective program data) or the like, and the other area is used as an area for storing data for rewriting obtained by downloading.

In a state shown in FIG. 2 (a), the program data currently used, for example, is stored in the first area E1. That is, the current program data, data obtained by compressing character font data (hereinafter referred to as compressed character data), and data obtained by compressing figure bit map data (hereinafter referred to as compressed figure data) are stored in the first area E1.

Character font data obtained by decompressing (expanding) the compressed character data in the first area E1 and figure bit map data obtained by decompressing the compressed figure data in the first area E1 are stored in the second area E2. In creating an operation screen such as a program table or a menu, the character font data and the figure bit map data after the decompression which are stored in the second area E2 are used. Various types of data are stored in the volatile memory 22.

The system controller 20 stores in the volatile memory 22 the attached information fed from the DEMUX circuit 3. A remote control signal from a remote control transmitter 12 is inputted to the system controller 20 through a remote controller receiver 13.

The system controller 20 sends information for channel selection, for example, to the tuner 2 and the DEMUX circuit 3. Further, the system controller 20 feeds to an OSD (On-Screen Display) display circuit 14 an OSD control signal for subjecting various types of operation screens to on-screen display on a CRT (Cathode-Ray Tube) 8. The OSD display circuit 14 produces display data such as a program guide or a menu and feeds the produced display data to a multiplexer (a synthesizing circuit) 6 as an OSD signal.

The AV decoder 4 demodulates MPEG (Motion Picture Expert Group) data fed from the DEMUX circuit 3. A video signal obtained by the AV decoder 4 is fed to the multiplexer 6 through a video processing circuit 5. The multiplexer 6 superimposes the display data fed from the OSD display circuit 14 on the video data outputted from the video processing circuit 5, and feeds the video data having the display data superimposed thereon to a video output circuit 7. A video signal outputted from the video output circuit 7 is fed to the CRT 8.

An audio signal obtained by the AV decoder 4 is fed to a speaker 11 through an audio processing circuit 9 and an audio output circuit 10.

When data for rewriting including program data for rewriting, compressed character data for rewriting, and compressed figure data for rewriting is sent out by broadcasting, the system controller 20 acquires a download control table (DCT) on the basis of the attached information. The download control table includes a maker ID, a model ID, and a version ID.

The system controller 20 judges whether or not the maker ID and the model ID are adapted to the digital television broadcasting receiver. When the IDs are adapted to the digital television broadcasting receiver, it is judged whether or not the version ID is newer than that assigned to a currently carried program. When the version ID is newer than that assigned to the currently carried program, it is possible to start downloading.

In order to start the downloading, a user operates the remote controller transmitter 12 to call a menu screen, select a downloading menu, and enter a downloading instruction.

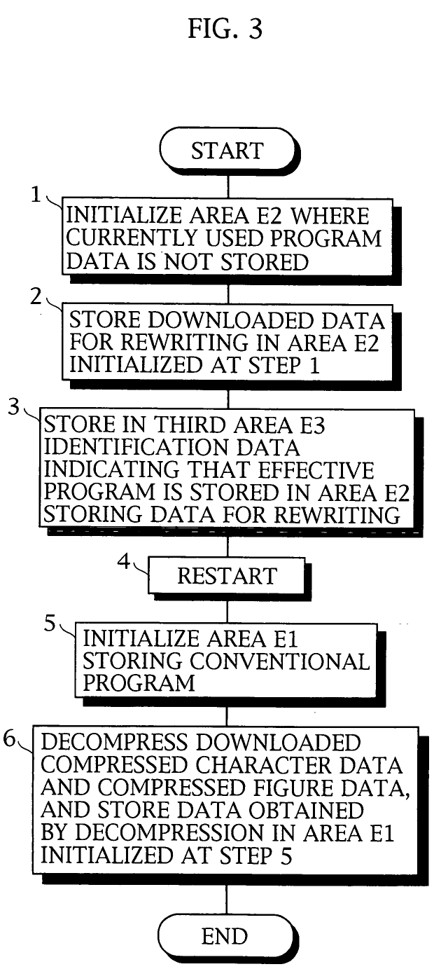

FIG. 3 illustrates the procedure for processing performed by the system controller 20 in a case where a downloading instruction is entered.

When the downloading instruction is entered, the area where the program data currently used is not stored out of the first area E1 and the second area E2 in the nonvolatile memory 21 (the second area E2 in this example) is initialized (step 1).

Thereafter, when the downloading of the data for rewriting is started, the downloaded data for rewriting is stored in the area initialized at the step 1 (the second area E2) (step 2). The reason why the data for rewriting is stored in the area where the current control program is not stored is that when the downloading is not normally terminated, the program used before the downloading is started can be executed by restarting the receiver.

When the downloading is normally completed, identification data indicating that the currently effective program is stored in the area storing the data for rewriting (the second area E2) is stored in the third area E3 (step 3). Thereafter, the receiver is restarted (step 4), to switch the effective program to a program newly downloaded.

The area storing the conventional program data (the first area E1) is not required. Accordingly, the area is initialized (step 5). The compressed character data and the compressed figure data which have been downloaded are respectively decompressed, and character font data and figure bit map data obtained by the decompression are stored in the area initialized at the step 5 (the first area E1) (step 6).

When the contents of the nonvolatile memory 21 before the downloading are as shown in FIG. 2 (a), therefore, the contents of the nonvolatile memory 21 after performing the processing at the step 6 are as shown in FIG. 2 (b).

According to the first embodiment, the currently effective program data as well as the data obtained by compressing the character font data and the data obtained by compressing the figure bit map data are stored in one of the first area E1 and the second area E2. Accordingly, the capacity of-the first area E1 and the second area E2 can be reduced.

The data obtained by decompressing the compressed data is stored in the area where the currently effective program data is not stored out of the first area E1 and the second area E2. Accordingly, a processing time period during the execution of the program is the same as that in a case where no compressed data is used.

The data which is hardly changed, for example, channel information in the attached information may be stored in the area (the first area E1 in this example) storing the character font data and the figure bit map data which are obtained by the decompression out of the first area E1 and the second area E2 in the nonvolatile memory 21.

[2] Description of Second Embodiment

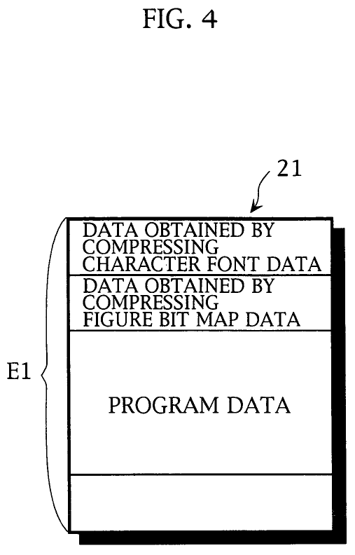

Also in a receiver having no program rewriting function, data obtained by compressing character font data (compressed character data) and data obtained by compressing figure bit map data (compressed figure data) may be stored in addition to program data in a program memory (a nonvolatile memory) 21, as shown in FIG. 4, to decompress and use the compressed data when the receiver is initially started or while processing for drawing a program table, a menu, or the like is being executed. In this case, an area for storing data for rewriting need not be provided in the program memory 21. Further, an unrewritable nonvolatile memory such as a ROM may be used as the program memory 21.

When the compressed data is decompressed at the time of initially starting the receiver, data after the decompression may be stored in a volatile memory 22. Consequently, a processing time period is required to decompress the compressed data at the time of initially starting the receiver. However, the compressed data need not be decompressed at the time of processing for drawing a program table, a menu, or the like. Accordingly, the drawing processing speed is high.

On the other hand, when the data obtained by compressing the character font data and the figure bit map data which are required while the processing for drawing a program table, a menu, or the like is being performed, the compressed data need not be decompressed at the time of initially starting the receiver. However, the drawing processing speed is decreased.

According to the second embodiment, the data obtained by compressing the character font data and the data obtained by compressing the figure bit map data are stored in the program memory. Accordingly, the capacity of the program memory can be reduced.

Although the present invention has been described and illustrated in detail, it is clearly understood that the same is by way of illustration and example only and is not to be taken by way of limitation, the spirit and scope of the present invention being limited only by the terms of the appended claims.

1-2. (canceled)

3. A digital television broadcasting receiver comprising:
a control section for controlling the whole of the receiver;
a program memory including an electrically rewritable nonvolatile memory having first and second program storing areas for storing program data for the control section and character and figure data used for drawing various types of operation screens, wherein program data currently used and data obtained by compressing the character and figure data are stored in the first program storing area, and data obtained by decompressing said character and figure data that was compressed and stored in the first program storing area being stored in the second program storing area;
means for downloading data for rewriting including program data for rewriting and compressed character and figure data for rewriting, and being fed by broadcasting, and for storing the downloaded data for rewriting in the second program storing area; and
means for initializing the first program storing area different from the second program storing area storing the data for rewriting after the downloading of the data for rewriting is terminated, and for decompressing and storing the compressed character and figure data for rewriting acquired by the downloading in the initialized first program storing area.

4. The digital television broadcasting receiver according to claim 3, further comprising a means for storing attached information fed by broadcasting is provided in the first program storing area storing data obtained by decompressing the compressed character and figure data for rewriting acquired by the downloading.

5. A digital television broadcasting receiver comprising:
a control section for controlling the whole of the receiver;
a program memory including an electrically rewritable nonvolatile memory having first and second program storing areas for storing program data for the control section and character and figure data used for drawing various types of operation screens, wherein the program data currently used and compressed character and figure data obtained by compressing said character and figure data are stored in the first program storing area, and data obtained by decompressing said compressed character and figure data are stored in the second program storing area;
a circuit for downloading data for rewriting including program data for rewriting and compressed character and figure data for rewriting, and being fed by broadcasting, and for storing the downloaded data for rewriting in the second program storing area; and
a circuit for initializing the first program storing area different from the second program storing area storing the data for rewriting after the downloading of the data for rewriting is terminated, and for decompressing and storing the compressed character and figure data for rewiring acquired by the downloading in the initialized first program storing area.

6. The digital television broadcasting receiver according to claim 5, wherein
further comprising a circuit for storing attached information fed by broadcasting is provided in the first program storing area storing data obtained by decompressing the compressed character and figure data for rewriting acquired by the downloading.
